(19) United States
(12) Patent Application Publication
(10) Pub. No.: US 2006/0249595 A1
(43) Pub. Date: Nov. 9, 2006

(54) Watering device with setup mode

(75) Inventors: Daniel J. Lipscomb, Prairie du Sac, WI (US); Scott Roelke, Arena, WI (US); David L. Vaughan, Cross Plains, WI (US); Lorena E. Yin, Madison, WI (US); Anthony W. Konkler, Lodi, WI (US)

Correspondence Address: FOLEY & LARDNER LLP, 777 EAST WISCONSIN AVENUE, MILWAUKEE, WI, 53202-5306, US

(73) Assignee: Fiskars Brands, Inc.

(21) Appl. No.: 11/114,912

(22) Filed: Apr. 26, 2005

(51) Int. Cl. B05B 3/16

(52) U.S. Cl. 239/242; 239/240; 239/562; 239/563

(57) ABSTRACT

A watering device includes a sprinkler member having a plurality of sprinkling orifices configured to distribute a fluid over a coverage area during a sprinkling mode and at least one setup orifice configured to direct a stream of the fluid substantially along a boundary of the coverage area during a setup mode. A valve member operates between a first position to direct a supply of the fluid to the setup orifice during the setup mode and a second position to direct a supply of the fluid to the sprinkling orifices during the sprinkling mode.

### FIELD

The present invention relates to a watering device, and more specifically to a sprinkler having a setup mode of operation and a sprinkling mode of operation.

### BACKGROUND

It is generally known to provide watering devices such as sprinklers (e.g. lawn sprinklers, garden sprinklers, etc.) for use in residential and commercial applications to distribute water over a desired coverage for hydrating lawns, plants, agricultural and horticultural products, etc. Such sprinklers are usually configured to distribute a stream, spray or fan of water in a certain pattern over a “coverage” area. Some of the known sprinklers also have adjustment features that permit adjusting the pattern of the water to change the boundaries of the coverage area. However, such known sprinklers generally do not realize certain advantageous features (and/or combinations of features). For example, the sprinklers with adjustment features usually do not permit operation of the sprinkler in a “setup” mode of operation in a manner that permits a user to identify and adjust the boundaries of the coverage area, before operation of the sprinkler in a “sprinkling” mode of operation that distributes water over the coverage area.

Therefore, it would be desirable to provide a watering device such as a sprinkler that is operable in a setup mode of operation and a sprinkling mode of operation to permit a user to predefine and adjust the boundaries of a coverage area for the sprinkler. It would also be desirable to provide a sprinkler having a device intended to permit a user to easily switch operation of the sprinkler between the setup mode and the sprinkling mode. It would further be desirable to provide a sprinkler having a time-delay feature that delays initiation of the sprinkling mode for a sufficient duration to permit a user to exit the coverage area of the sprinkler and avoid being wetted after switching from the setup mode to the sprinkling mode.

Accordingly, it would be desirable to provide a watering device having any one or more of these or other advantageous features.

### SUMMARY

The present invention relates to a sprinkler with a sprinkler member having a plurality of sprinkling orifices configured to distribute a fluid over a coverage area during a sprinkling mode and at least one setup orifice configured to direct a stream of the fluid substantially along a boundary of the coverage area during a setup mode. A valve member operates between a first position to direct a supply of the fluid to the setup orifice during the setup mode and a second position to direct a supply of the fluid to the sprinkling orifices during the sprinkling mode.

The present invention also relates to a watering device that includes a substantially hollow member having a first flow path communicating with a first set of orifices to distribute a supply of water over a watering area during a watering mode, and a second flow path communicating with a second set of orifices to distribute a supply of water substantially along opposite edges of the watering area during a setup mode. A mode switch operates to direct a supply of water through the first flow path during the watering mode and to direct a supply of water through the second flow path during the setup mode.

The present invention further relates to a watering device that includes a sprinkler head movable between a first position and a second position. The sprinkler head includes a plurality of watering apertures configured to receive a supply of water during a watering mode for wetting a coverage area as the sprinkler head moves between the first position and the second position. The sprinkler head also includes a first setup aperture and a second setup aperture configured to receive the supply of water during a setup mode and deliver a stream of water defining at least a portion of a boundary of the coverage area as the sprinkler head moves between the first position and the second position. A valve device operates to direct the supply of water to the setup apertures during the setup mode and to direct a supply of water to the watering apertures during the watering mode.

### BRIEF DESCRIPTION OF THE DRAWINGS

FIG. 1A is a schematic representation of a perspective view of a sprinkler in a setup mode of operation according to an exemplary embodiment.

FIG. 1B is a schematic representation of a perspective view of a sprinkler in a sprinkling mode of operation according to an exemplary embodiment.

FIG. 2A is a schematic representation of a perspective view of a portion of a sprinkler in a setup mode of operation for a coverage area according to another exemplary embodiment.

FIG. 2B is a schematic representation of a perspective view of a portion of a sprinkler in a sprinkling mode of operation for a coverage area according to an exemplary embodiment.

FIG. 3A is a schematic representation of a perspective view of a portion of a sprinkler in a setup mode of operation for another coverage area according to an exemplary embodiment.

FIG. 3B is a schematic representation of a perspective view of a portion of a sprinkler in a sprinkling mode of operation for another coverage area according to an exemplary embodiment.

FIG. 4A is a schematic representation of a front elevation view of a sprinkler in a sprinkling mode for a coverage area according to an exemplary embodiment.

FIG. 4B is a schematic representation of a front elevation view of a sprinkler in a sprinkling mode for another coverage area according to an exemplary embodiment.

FIG. 5A is a schematic representation of a front elevation view of a sprinkler in a setup mode for a coverage area according to an exemplary embodiment.

FIG. 5B is a schematic representation of a front elevation view of a sprinkler in a sprinkling mode for the coverage area of FIG. 5A.

FIG. 6A is a schematic representation of a front elevation view of a sprinkler in a setup mode for a coverage area according to an exemplary embodiment.

FIG. 6B is a schematic representation of a front elevation view of a sprinkler in a sprinkling mode for the coverage area of FIG. 6A.

FIG. 7A is a schematic representation of a front elevation view of a sprinkler in a setup mode for a coverage area according to an exemplary embodiment.

FIG. 7B is a schematic representation of a front elevation view of a sprinkler in a sprinkling mode for the coverage area of FIG. 7A.

### DETAILED DESCRIPTION

Referring to the FIGURES, a watering device (e.g. sprinkler, irrigator, etc.) is shown having structure for operation of the sprinkler in a setup mode of operation and a sprinkling mode of operation according to an exemplary embodiment. The sprinkler includes a sprinkler member (e.g. sprinkler head, etc.) shown with a plurality of sprinkling orifices (e.g. apertures, nozzles, etc.) for distributing a supply of water in a pattern over a coverage area (e.g. sprinkling area, watering area, etc.) during the sprinkling mode for watering or hydrating lawns, gardens, plants, shrubs, trees, landscaping, or other agricultural and/or horticultural products in either a residential or commercial application. The coverage area may have any suitable shape (e.g. rectangular, circular, etc.) for wetting a desired area. The sprinkler is also shown to include an adjustment device intended to permit changing the pattern of water discharged from the sprinkling orifices. The adjustment device is shown as a pair of positioners (e.g. levers, cams, etc.) for modifying the shape of the sprinkler head, however, any suitable adjustment device may be used with any form of sprinkler head that is sufficient to adjust the direction and/or pattern of water discharged from the sprinkler orifices so that a desired coverage area may be established by a user. The sprinkler is also shown having a setup orifice (e.g. aperture, etc.) positioned at each end of a line of the sprinkling orifices so that a supply of water may be directed through the setup orifices to define outer boundaries of the coverage area during a setup mode of operation. A stream of water discharged from the setup orifices are intended to at least partially define the boundaries of the coverage area so that a user may adjust the sprinkler head to establish desired boundaries for the coverage area in a particular application prior to initiating the sprinkling mode and wetting the coverage area. The sprinkler is also shown to include a valve device (e.g. mode switch, etc.) operable to direct a supply of water to the setup orifices during the setup mode and to the sprinkling orifices during the sprinkling mode. A delay or timer feature is associated with the valve device so that a user may switch the sprinkler from the setup mode to the sprinkling mode and then exit the coverage area before initiation of the sprinkling mode to avoid being wetted by the sprinkler. Many modification to the components, features and operation of the subject matter shown and described are possible. Accordingly, all such modifications are intended to be included within the scope of the present inventions.

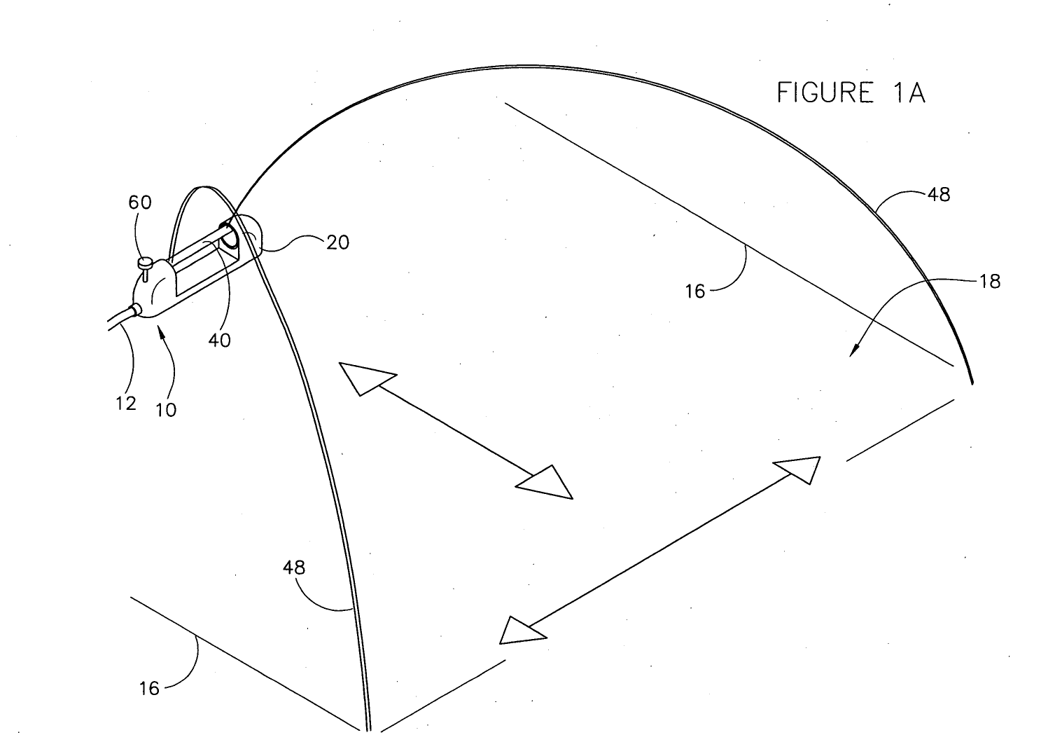

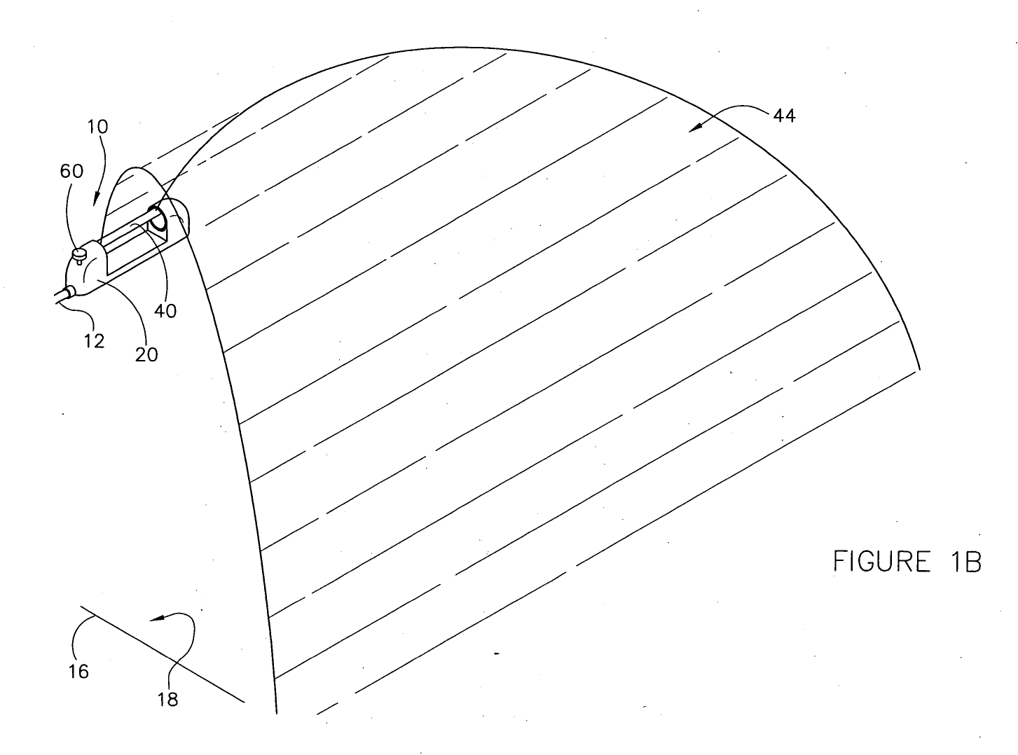

Referring to FIGS. 1A and 1B, a sprinkler 10 is shown having a setup mode of operation and a sprinkling (e.g. watering, etc.) mode of operation according to an exemplary embodiment. Sprinkler 10 is shown as an “oscillating” type sprinkler having a body portion 20 adapted for connection to a supply of water (shown for example as a water hose 12) and a sprinkler head portion 40 movably mounted on body portion 20 for discharging the supply of water. During a setup mode (see FIGS. 1A, 2A and 3A), the supply of water is shown discharged in “streams” 48 intended to at least partially define the boundaries 16 (e.g. outer edges, lateral sides, etc.) of a coverage area 18. During a sprinkling mode of operation (see FIGS. 1B, 2B and 3B), the supply of water is shown discharged in a pattern (e.g. fan, etc.—shown as spray 44) over coverage area 18 for wetting objects within coverage area 18. The setup mode is intended to permit a user to determine or establish a desired coverage area as defined by streams 48 by adjusting sprinkler head 40 as necessary, without being wetted by spray 44 of water associated with the sprinkling mode, as may tend to occur in conventional sprinklers that do not include a setup mode of operation. Sprinkler 10 is also shown to include a valve device 60 configured to redirect (e.g. switchover, etc.) a flow of water in the sprinkler between the setup mode (FIG. 1A) and the sprinkling mode (FIG. 1B). Valve device 60 includes a timer device 64 that functions to delay initiation of the sprinkling mode after switchover from the setup mode for a sufficient duration to permit the user to exit the coverage area 18 without being wetted by the spray of water.

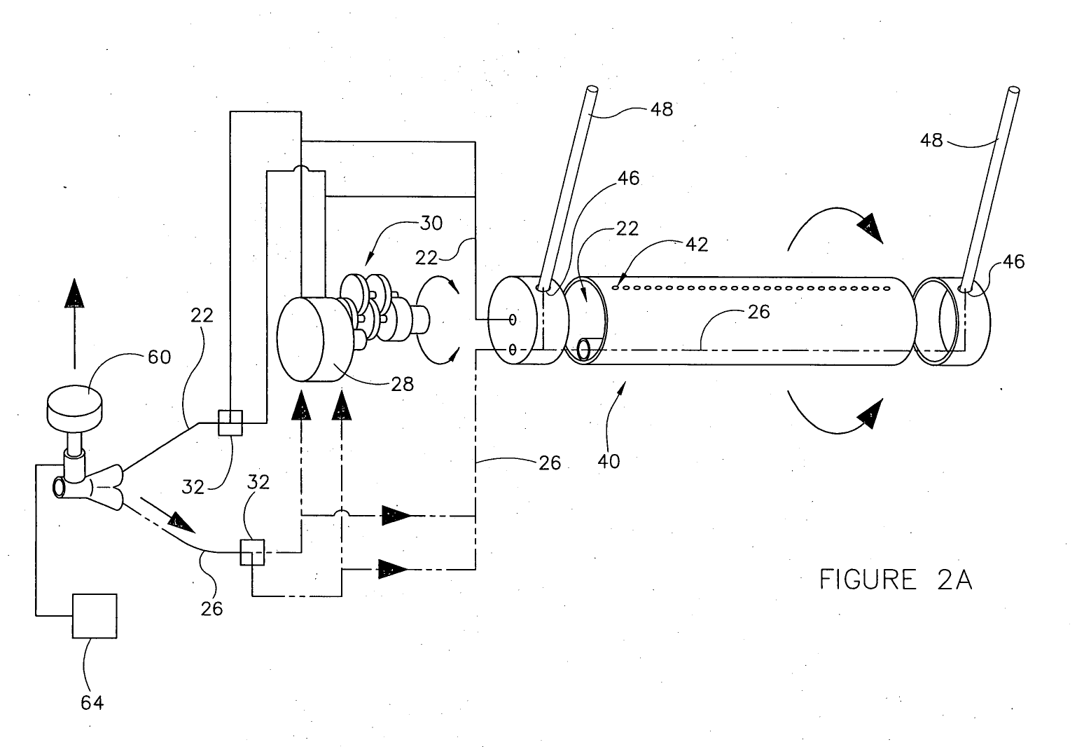

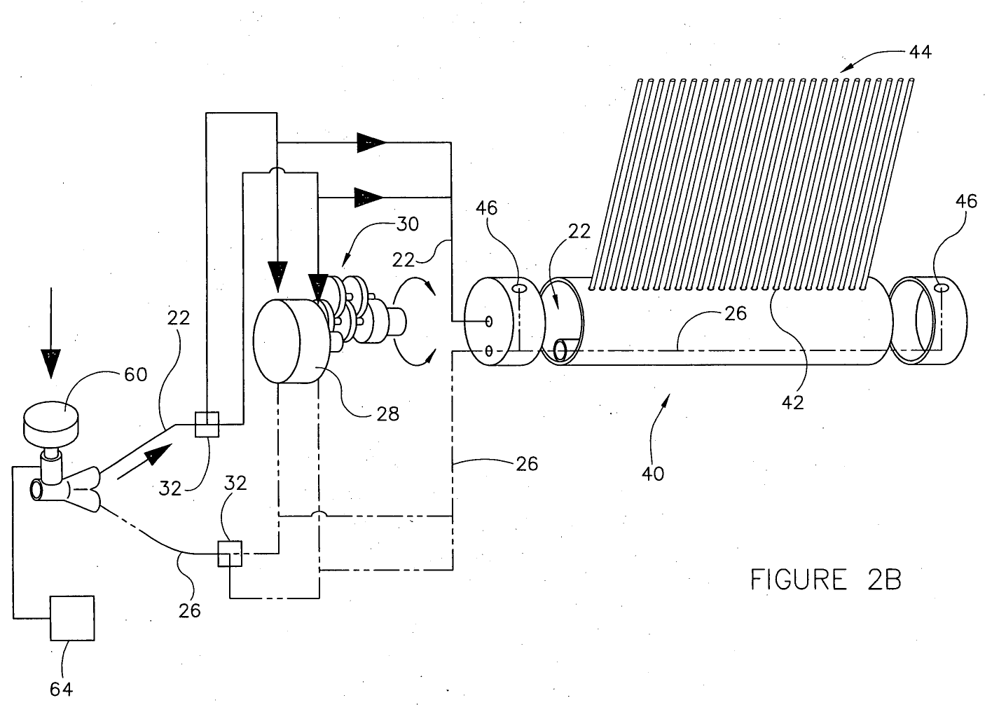

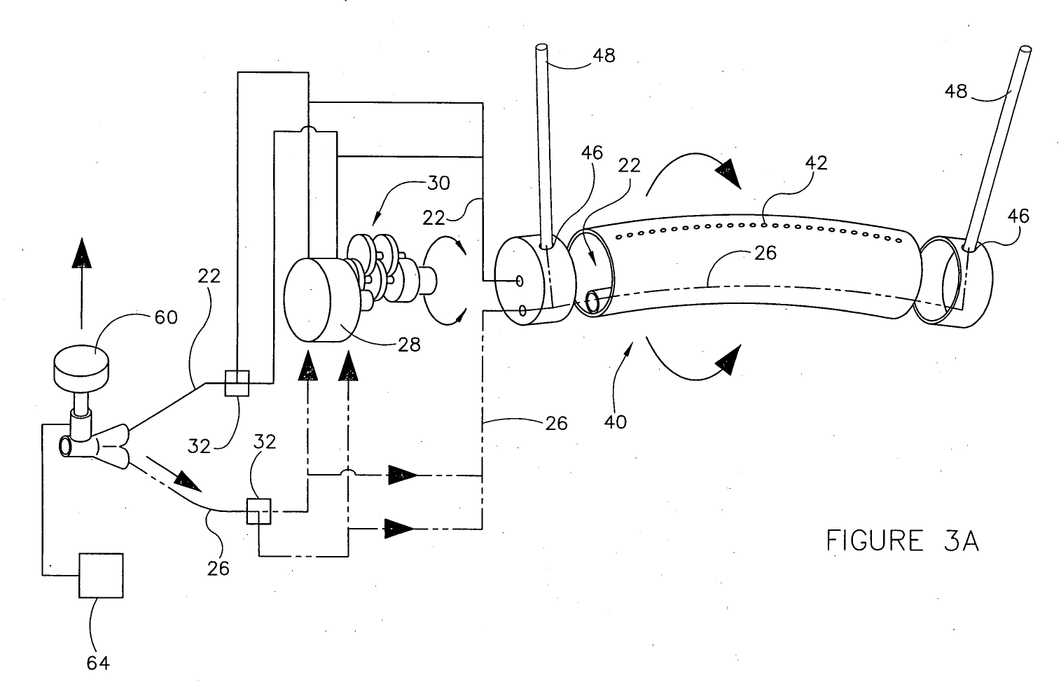

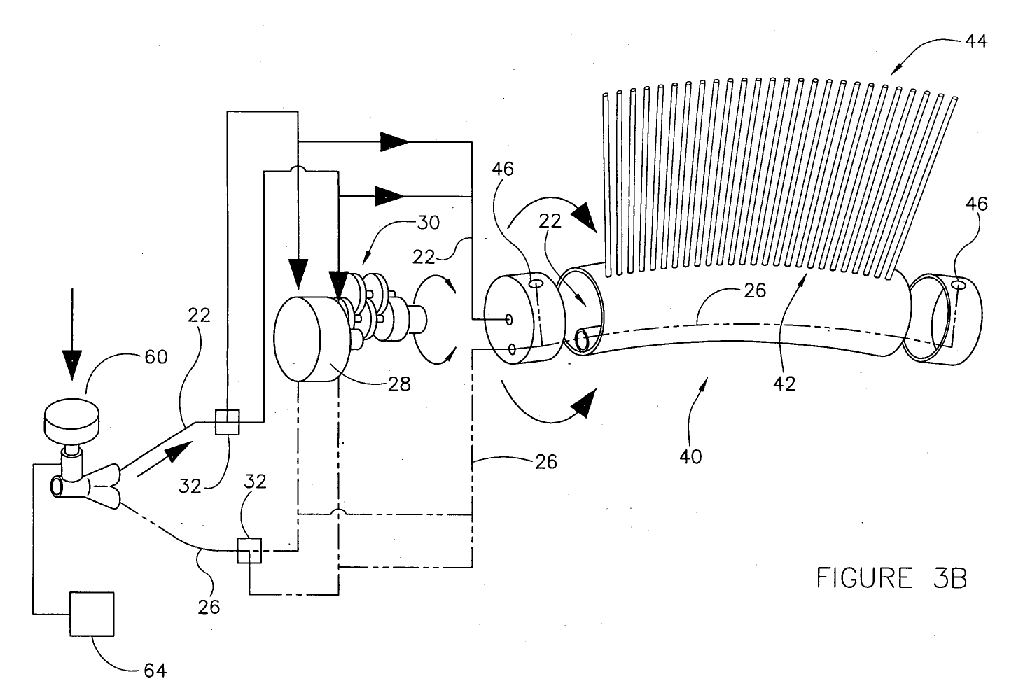

Referring to FIGS. 2A-3B, a portion of sprinkler 10 and sprinkler head 40 are shown according to an exemplary embodiment. Sprinkler head 40 is shown as a generally flexible, hollow, elongated member (e.g. tube, etc.) configured for generally rotational (oscillating) movement about its longitudinal axis between a first position and a second position for distributing water over coverage area 18. Sprinkler head 40 includes a first set of orifices (shown as watering or sprinkling orifices 42 having a generally uniform diameter) arranged in a line (shown as a straight line, but may have an arcuate, curvilinear, or other arrangement according to alternative embodiments) for discharging a supply of water (e.g. fan, etc.—shown as spray 44) over coverage area 18 as sprinkler head 40 moves between the first and second positions. Sprinkler head 40 is also shown to include a second set of orifices (shown as a pair of setup orifices 46 having a generally uniform diameter that is larger than sprinkler orifices 42) positioned generally adjacent to opposite ends of the line of sprinkling orifices 42 and configured to discharge streams 48 of water during the setup mode. According to alternative embodiments, the sprinkler orifices and setup orifices may have any desirable shape and size, and may each have a common size or varying sizes.

The body portion 20 of sprinkler 10 is also schematically shown to include a first flow path (shown as a sprinkling flow path 22) extending between valve device 60 and sprinkler head 40. When valve device 60 is in a first position, a supply of water is directed through sprinkling flow path 22 to sprinkling orifices 42 for discharge as spray 44 from sprinkler head 40 in the sprinkling mode. Body portion 20 of sprinkler 10 is also schematically shown to include a second flow path (shown as a setup flow path 26) extending between valve member 60 and sprinkler head 40. When valve device 60 is in a second position, the supply of water is directed through second flow path 26 to setup orifices 46 for discharge as streams 48 from sprinkler head 40 in the setup mode. The first and second flow paths 22, 26 may be formed within body portion 40 of the sprinkler in any suitable manner, such as with tubing and fittings, or integrally formed passages within the body portion (e.g. molded channels, conduits, etc.).

Referring further to FIGS. 2A-3B, first and second flow paths 22, 26 are also schematically shown to interface with an oscillating mechanism 28 (e.g. impeller, rotor, water-wheel, etc.) coupled to a drive mechanism 30 (e.g. gear train, etc.) for rotating sprinkler head 40 in an oscillating manner during the setup mode and the sprinkling mode. According to one embodiment, each flow path includes a valve member 32 (e.g. of a conventional type) configured to alternatively direct a flow of, water to opposite sides of oscillating mechanism 28 for operation in alternating directions (e.g. clockwise and counterclockwise, etc.) to rotate sprinkler head 40 in an oscillating manner between the first and second positions.

According to an exemplary embodiment, the first flow path 22 and second flow path 26 are shown to be substantially independent and arranged to direct the supply of water only to sprinkling orifices 42 when valve member 60 is in the first position for operation of the sprinkler in the sprinkling mode, and to direct the supply of water only to setup orifices 46 when the valve member 60 is in the second position for operation of the sprinkler in the setup mode. According to alternative embodiments, the flow paths may be at least partially “common” and may also be configured to direct any suitable portion of the water supply to the sprinkling and setup orifices during either mode of operation.

Valve device 60 may be any suitable device for permitting a user to manually direct the supply of water between the first flow path and the second flow path. According to the illustrated embodiment in FIGS. 2A-3B, valve device 60 includes an extendable and retractable stem (e.g. plunger, etc.—of a conventional type) for controlling the direction of the flow of water. However, the valve member may also be a rotational member (e.g. ball-type valve, butterfly-type valve, etc.—of a conventional type) for switching the direction of the flow of water between the first and second flow paths. Valve device 60 is also shown to include a timer device 64 intended to delay initiation of the sprinkling mode upon actuating valve member 60 from the second position (setup mode) to the first position (sprinkling mode) for a suitable time period so that a user may retreat from the sprinkler or otherwise exit the coverage area without being “sprayed” or otherwise wetted by the sprinkler when setup is complete and the sprinkling mode is selected. According to one embodiment, the timer device 64 is a gear and spring type mechanism. The time delay duration may be any suitable duration to permit a typical user to walk from the sprinkler to a location outside of the coverage area. According to one embodiment, the time delay duration is within the range of approximately 10-30 seconds. However, other suitable time delay durations may be provided depending on factors such as the intended environment for the sprinkler, the range of coverage area for the sprinkler, etc. According to alternative embodiments, the timer device may use any suitable time delay mechanism.

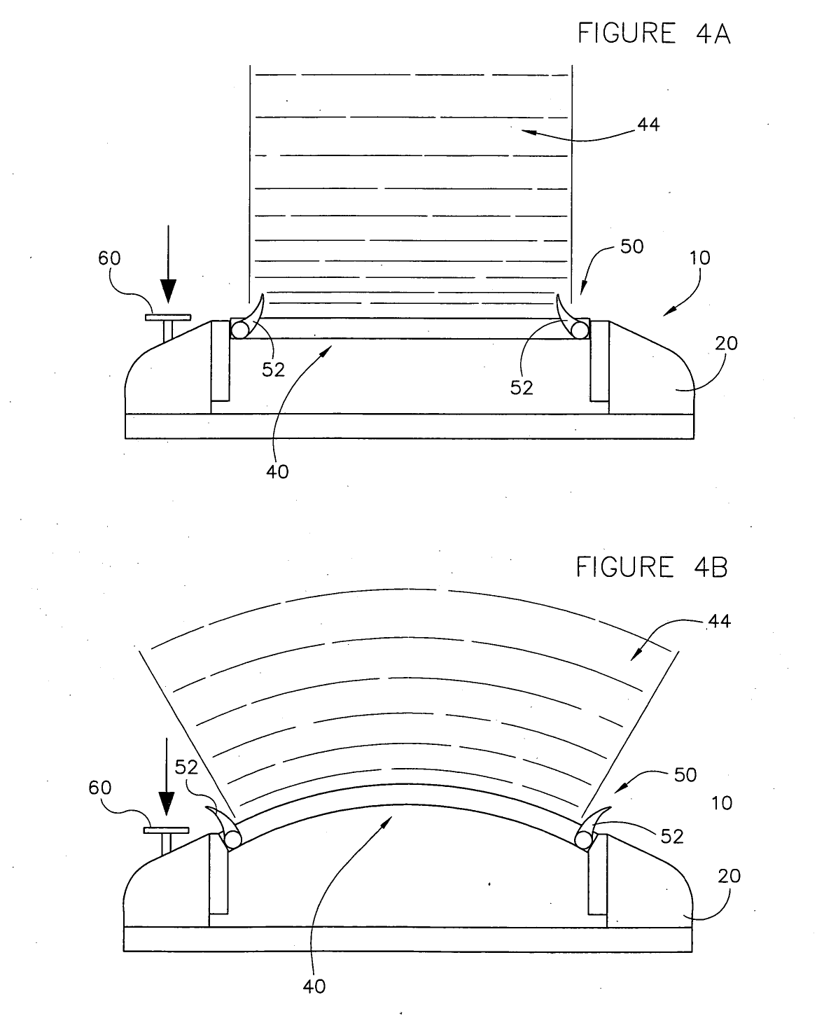

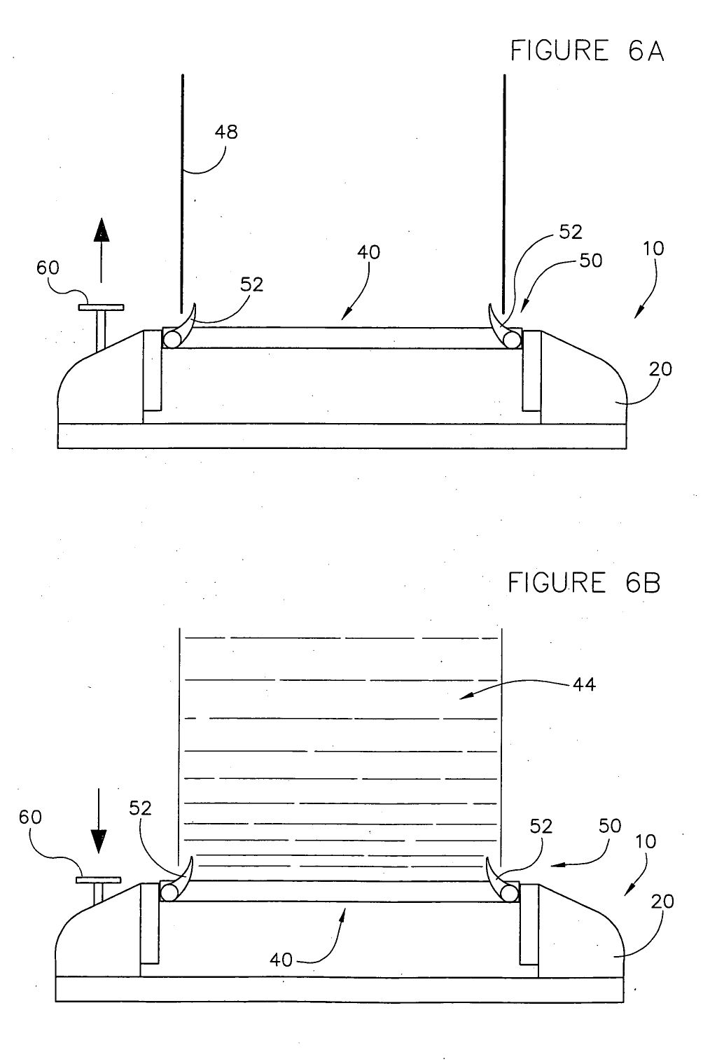

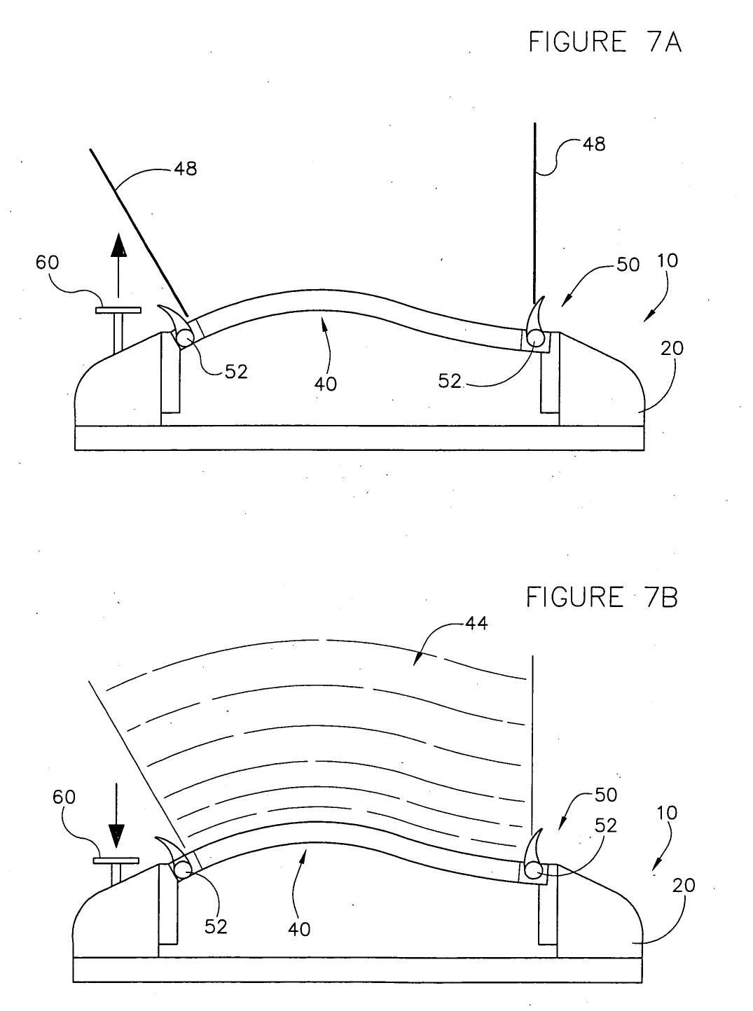

Referring to FIGS. 4A-7B, an adjustment device 50 for sprinkler 10 is shown according to an exemplary embodiment. Sprinkler head 40 is shown to include a generally “flexible” hollow member (e.g. tube, etc.) adjustable between a first shape (shown as a generally “straight” shape in FIG. 4A) and a variety of other shapes (shown as a generally “arched” or “bowed” shape in FIG. 4B). According to the illustrated embodiment, orifices 42, 46 are through-holes in the wall of the hollow member such that water discharged from either sprinkler orifices 42 or setup orifices 46 projects in a direction that is generally perpendicular to a tangent of the tube wall at each orifice location. Accordingly, the pattern of water discharged from the orifices may be adjusted by adjusting the shape of the hollow member.

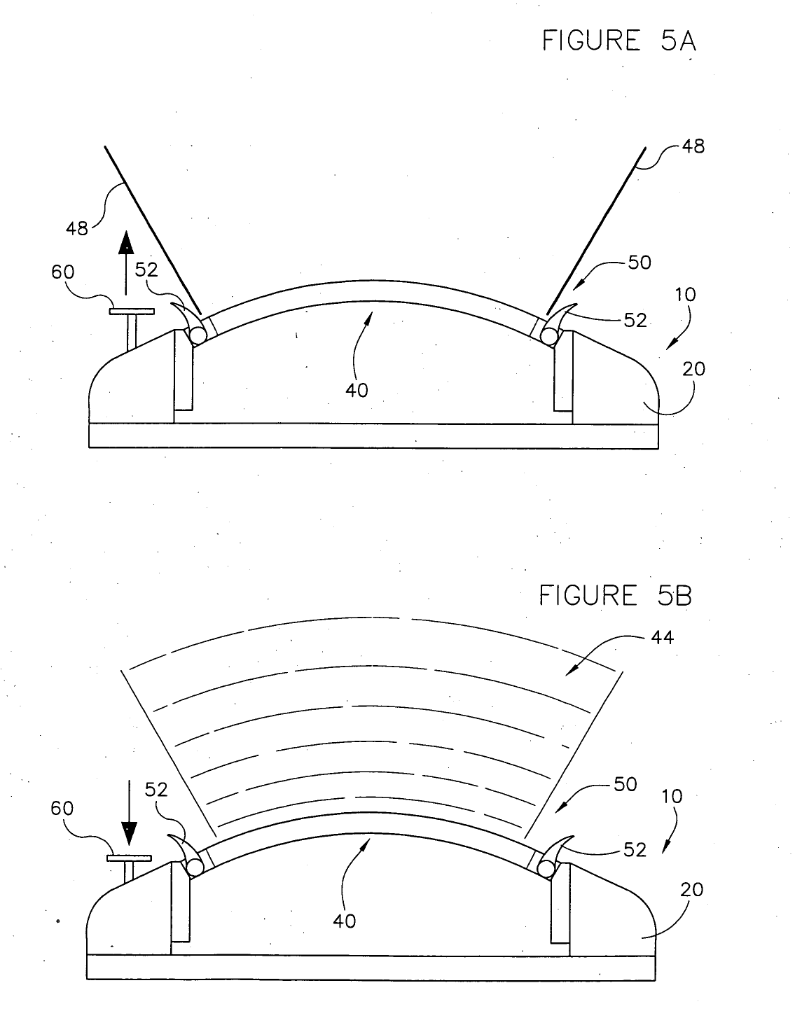

Adjustment device 50 is shown to include positioners 52 (e.g. cams, levers, etc.) located generally at opposite ends of the hollow member. Positioners 52 are independently movable and may be used individually or in combination to adjust the hollow member into any desired shape to create a variety of patterns for spray 44 and boundaries for coverage area 18. Sprinkler 10 may be operated in the setup mode and the positioners 52 adjusted to modify the shape of the hollow member to define, change, modify, or otherwise establish a coverage area (see FIGS. 5A, 6A and 7A) for wetting desired objects when the sprinkler is switched from the setup mode to the sprinkling mode (see FIGS. 5B, 6B and 7B). Alternatively, the setup mode may be bypassed and the coverage area of the sprinkler may be directly adjusted during the sprinkling mode.

According to any preferred embodiment, a sprinkler is provided that is operable in a setup mode for predefining and establishing an intended coverage area for watering objects that permits adjustment without “wetting” the user. The sprinkler includes a switching device such as a valve that switches operation from the setup mode to a sprinkling (e.g. watering mode, etc.) for watering the objects in the coverage area. The sprinkler also includes a time delay device that delays “switchover” from the setup mode to the watering mode so that a user may remain dry during setup and operation of the sprinkler. According to any exemplary embodiment, the sprinkler head includes an adjustment device for modifying the pattern of water discharged from the sprinkler head to suit a desired coverage area. The sprinkler head also includes apertures or orifices for streaming the supply of water along boundaries of the coverage area during the setup mode and for distributing the supply of water over the coverage area during the watering mode. The setup orifices may be distinct from the sprinkling orifices, or may be configured as a certain subset of the sprinkling orifices (e.g. one or more outward sprinkling orifices, etc.).

According to any alternative embodiment, the sprinkler may have any suitable type of oscillating mechanism and valve members. Also, the sprinkler head may have any suitable shape and configuration for distributing a desired pattern of water over an intended coverage area. In addition, the positioners of the adjustment system may be provided in any suitable form and location for changing the pattern of water discharged from the orifices. Further, the orifices may be provided as nozzles or other suitable structure intended to direct a discharge of water in a desired direction.

It is important to note that the construction and arrangement of the elements of the sprinkler as shown and described in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the setup mode, valve members, timing device and oscillation mechanism may be reconfigured, actuation-assisted, or otherwise varied, or the length, width or orientation of the structures and components or other elements of the sprinkler may be varied. It should be noted that the elements and/or assemblies of the sprinkler may be constructed from any of a wide variety of materials that provide sufficient strength, durability and water resistance, in any of a wide variety of colors, textures, shapes and combinations. It should also be noted that the body portion of the sprinkler may be configured in any suitable shape and used in association with a wide variety of water supplies to support use in any of a wide variety of residential, commercial and/or agricultural applications. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A sprinkler, comprising:
a sprinkler member having a plurality of sprinkling orifices configured to distribute a fluid over a coverage area during a sprinkling mode and at least one setup orifice configured to direct a stream of the fluid substantially along a boundary of the coverage area during a setup mode; and
a valve member operable between a first position to direct a supply of the fluid to the setup orifice during the setup mode and a second position to direct a supply of the fluid to the sprinkling orifices during the sprinkling mode.

2. The sprinkler of claim 1 wherein the at least one setup orifice is a first setup orifice adjacent a first end of the sprinkling orifices and a second setup orifice adjacent a second end of the sprinkling orifices.

3. The sprinkler of claim 2 wherein the first setup orifice and the second setup orifice are configured to direct a stream of water substantially along lateral boundaries of the coverage area.

4. The sprinkler of claim 1 wherein the sprinkler member comprises a substantially hollow member configured for flow of the fluid.

5. The sprinkler of claim 1 wherein the sprinkler member comprises an adjustment device configured to change the coverage area.

6. The sprinkler of claim 1 further comprising a timer device coupled to the valve member and configured to provide a time delay associated with repositioning the valve member from the first position to the second position, so that a user may exit the coverage area.

7. A watering device, comprising:
a substantially hollow member having a first flow path communicating with a first set of orifices to distribute a supply of water over a watering area during a watering mode, and a second flow path communicating with a second set of orifices to distribute a supply of water substantially along opposite edges of the watering area during a setup mode;
a mode switch operable to direct a supply of water through the first flow path during the watering mode and to direct a supply of water through the second flow path during the setup mode.

8. The watering device of claim 7 wherein the first set of orifices extend substantially in a line along the hollow member.

9. The watering device of claim 8 wherein the second set of orifices are located proximate opposite ends of the line of the first set of orifices.

10. The watering device of claim 9 wherein the second set of orifices comprise one orifice proximate each end of the line.

11. The watering device of claim 7 wherein the hollow member is movable for adjusting the watering area and the second set of orifices provide streams of water that substantially define boundaries of the watering area so that a user can adjust the boundaries during the setup mode without directing a flow of water through the first set of orifices.

12. The watering device of claim 7 further comprising a time delay device interfacing with the mode switch and operable to delay redirection of the supply of water from the second flow path to the first flow path upon activation of the mode switch from the setup mode to the watering mode.

13. The watering device of claim 12 wherein the time delay device is adjustable to provide a delay within a predetermined range.

14. The watering device of claim 7 further comprising an oscillation mechanism for moving the hollow member through a predetermined range.

15. A watering device, comprising:
a sprinkler head movable between a first position and a second position;
a plurality of watering apertures on the sprinkler head configured to receive a supply of water during a watering mode for wetting a coverage area as the sprinkler head moves between the first position and the second position;
a first setup aperture and a second setup aperture on the sprinkler head configured to receive the supply of water during a setup mode and deliver a stream of water defining at least a portion of a boundary of the coverage area as the sprinkler head moves between the first position and the second position; and
a valve device operable to direct the supply of water to the setup apertures during the setup mode and to direct a supply of water to the watering apertures during the watering mode.

16. The watering device of claim 15 further comprising a timer configured to delay a transfer of the supply of water from the setup apertures to the watering apertures upon activation of the valve device by a user.

17. The watering device of claim 15 wherein the sprinkler head is a flexible tube member movable between a straight configuration and a plurality of arcuate configurations to adjust the coverage area.

18. The watering device of claim 15 wherein the sprinkler head further comprises a first flow path extending between the valve member and the watering orifices and a second flow path extending between the valve member and the setup orifices.

19. The watering device of claim 15 wherein the sprinkler head is movable between the first position and the second position in an oscillating manner.

20. The watering device of claim 15 wherein the first setup aperture and the second setup aperture each deliver a stream of water defining a lateral side of the coverage area.
